(19) United States
(12) Patent Application Publication
(10) Pub. No.: US 2025/0062702 A1
(43) Pub. Date: Feb. 20, 2025

(54) Use of an inverter switching arrangement for operating a system with electric drive

(71) Applicants: AUDI AG, Ingolstadt (DE); VOLKSWAGEN AKTIENGESELLSCHAFT, Wolfsburg (DE); FRIEDRICH-ALEXANDER-UNIVERSITAET ERLANGEN-NUERNBERG, KOERPERSCHAFT DES OEFFENTLICHEN RECHTS, Erlangen (DE)

(72) Inventors: Daniel RUPPERT, Lenting (DE); Cornelius RETTNER, Lauf an der Pegnitz (DE); Adrian AMLER, Nuernberg (DE); Jan ZACHARIAE, Braunschweig (DE)

(73) Assignees: AUDI AG, Ingolstadt (DE); VOLKSWAGEN AKTIENGESELLSCHAFT, Wolfsburg (DE); FRIEDRICH-ALEXANDER-UNIVERSITAET ERLANGEN-NUERNBERG, KOERPERSCHAFT DES OEFFENTLICHEN RECHTS, Erlangen (DE)

(21) Appl. No.: 18/807,077

(22) Filed: Aug. 16, 2024

(30) Foreign Application Priority Data
Aug. 17, 2023 (DE) 10 2023 122 100.0

(51) Int. Cl. H02M 7/5387; B60L 3/00

(52) U.S. Cl. CPC H02M 7/53871; B60L 3/003; B60L 2210/40

(57) ABSTRACT

In an example, an optimized inverter switching arrangement to operate a system with an electric drive may include an inverter circuit as a two-level inverter, which couples an alternating signal connection and a direct signal connection of the switching arrangement to each other. The inverter circuit may include at least two phases, which are each equipped with first switching elements as a half bridge. At least one second switching element is associated with each of the phases to form a hybrid circuit. The first and second switching elements differ in their semiconductor technology. By a control circuit, the inverter circuit may be operated in a short circuit operation to perform an active short circuit in case of a fault. The control circuit may control the first and second switching elements such that the alternating signal connection is short-circuited by each phase.

### CROSS-REFERENCE TO RELATED APPLICATIONS

This application claims the priority benefit of German Patent Application No. 10 2023 122 100.0 filed on Aug. 17, 2023, which is incorporated by reference herein in its entirety.

### BACKGROUND

### 1. Field

Examples of an invention may relate to an inverter switching arrangement for operating a system with electric drive. Furthermore, the examples of the invention may relate to a motor vehicle with a corresponding inverter switching arrangement as well as to a method for operating a corresponding inverter switching arrangement.

### 2. Description of the Related Art

Systems with electric drive such as for example an electrically operated motor vehicle, use an inverter switching arrangement to operate an electric drive, such as for example an electric motor or a driving machine, by electrical energy from an electrical energy storage (battery, accumulator). Therein, the inverter switching arrangement has the function to convert the electrical energy, which is usually provided as direct current or DC voltage, into an electrical AC voltage or an alternating current, which is suitable for the operation of the electric drive. In the motor vehicle area, such an inverter switching arrangement is also referred to as converter, in particular drive converter.

In today's motor vehicles, drive converters are usually designed according to the topology of a two-level inverter. A two-level inverter emulates an alternating signal (alternating current, AC voltage) suitable for the excitation of the drive machine by higher-frequency switching of the outputs thereof. In a two-level inverter, each output is connected to a DC voltage intermediate circuit, thus an input, to which the battery is for example connected, by a half bridge. In a two-level inverter, a half bridge includes two semiconductor switches connected in series. In a normal operation, they are operated in a switching operation for converting the direct signal (direct current, DC voltage) into the alternating signal. For the implementation of the two semiconductor switches of the half bridge, various semiconductor technologies are possible. Today, silicon (Si) IGBTs (Insulated Gate Bipolar Transistor) with antiparallel diode or silicon carbide (SiC) MOSFETs (Metal Oxide Semiconductor Field Effect Transistor) are predominantly used. Thus, they are semiconductors with different semiconductor technology, which for example differ by their respective switching speed in the switching operation.

The employment of semiconductor switches for inverting or rectifying electrical signals is known per se from the prior art.

For example, CN 110034685 A discloses the use of a hybrid switch of a silicon IGBT and a silicon carbide MOSFET for a “resonant dual active bridge” in a DC/DC converter. Thus, compared to a drive converter, a DC voltage converter is here concerned, which in turn has different requirements to the system.

From US 2016/0118381 A1, a hybrid switch of bipolar semiconductor switches is known. The hybrid switch is composed of a cascade of a self-conducting silicon carbide IGBT and for example a low-voltage MOSFET. Here, a hybrid switch of a series connection of semiconductor switches is thus used.

In terms of the functional safety of a drive system in an electric motor vehicle, it is important to avoid an undesired control of the drive machine. Therefore, there are drive converters, which are switched into a safe state in case of fault. Hereto, the so-called active short circuit (AKS) is preferred. In the active short circuit, the same semiconductor switches in each half bridge are controlled such that the respective output and thus the drive machine are short-circuited across the semiconductor switches. Therein, the drive machine generates current pulses with very high amplitude for a short time. These current pulses result in losses in the semiconductor switches of the converter, which can extend beyond the design limits thereof for the normal operation. Therefore, it is required to ensure in the active short circuit that the maximum temperature or peak temperature of the semiconductors does not exceed their maximum value.

The active short circuit as a securing measure is for example known from DE 10 2020 129 135 B3. Herein, a method and system for using a high-speed bus in an alternating current battery are disclosed.

### SUMMARY

According to at least one aspect of the present invention, an inverter switching arrangement may be provided in which an active short circuit can be implemented in case of fault considering design limits for the components thereof.

The aspects of the present invention may be the subject matter of the independent claims. Advantageous developments may be disclosed by the dependent claims, the description as well as the figures.

The aspects of the present invention may be based on the realization that the SiC MOSFET technology becomes accepted more and more in the last years. With respect to Si IGBTs, it in particular allows a higher switching speed. Due to the MOSFET-specific characteristic curve in their intended operation, MOSFETs are particularly efficient in particular in the low-load case. Thereby, they have an advantage with respect to the older IGBT technology in this case. Conversely, the forward voltage of IGBTs less severely rises at high currents. The conduction losses of MOSFETs are increased at higher currents and in the overload case with respect to a comparison at the IGBT.

Due to the higher conduction losses and the lower thermal mass, inadmissibly high temperatures increasingly occur in converters with SiC MOSFET switches in contrast to the IGBT technology upon design to the same normal operation (converter operation). Thereby, a defect of the converter can occur. For achieving the safe state in terms of the functional safety, therefore, another measure than the active short circuit would have to be selected. However, the implementation of other measures is usually very expensive. A measure can be in considerably increasing the chip area, thus the construction size of a SiC MOSFET. This results in more installation space requirement and in not justifiable additional costs.

Therefore, there is the idea to realize a hybrid switch or a hybrid circuit of semiconductor switches with different semiconductor technology such as for example the MOSFET and IGBT technology. Thus, the efficiency can be increased and material costs can be reduced compared to converters with pure SiC MOSFETs. In addition, such inverter switching arrangements with hybrid switch are optimized both for the normal operation and for the case of fault, in particular in the active short circuit. In particular, such hybrid switches are less prone to defect in case of fault and the capacity limits, in particular with respect to a temperature, can be complied with. Put another way, the concept of a hybrid switch can be employed for an inverter switching arrangement and be designed to the active short circuit to further maintain the advantages of a converter equipped with MOSFET in the normal operation.

Hereto, in an example, an inverter switching arrangement may be, for example, for a drive converter to operate an electrical system with an electric drive. The inverter switching arrangement includes an inverter connection for connecting a component, which is designed for an operation with an alternating signal. Presently, an alternating current and/or an AC voltage is in particular meant by an alternating signal. Thus, it is a signal with alternating polarity in the temporal course, thus a temporally variable or frequency-variable signal. Such an alternating signal is for example suitable for operating an electrical machine (drive machine) or an electric motor.

Furthermore, the inverter switching arrangement includes a direct signal connection for connecting a component, which is designed for an operation with a direct signal. Presently, a direct current and/or a DC voltage is in particular meant by a direct signal. This means that the direct signal has a constant polarity in the temporal course. For example, a direct signal is suitable for operating or for using with an electrochemical energy source, such as for example a battery, an accumulator or a fuel cell. In the motor vehicle area, such an energy storage is for example used as a drive battery or traction battery.

The inverter switching arrangement also includes an inverter circuit, which couples the alternating signal connection and the direct signal connection to each other. This means that the respective connections are connected to each other by the inverter circuit, thus electrically connected to each other. The inverter circuit can for example be formed in the manner of a two-level inverter or another inverter topology as initially described. The inverter circuit is also referred to as AC/DC converter (AC: Alternating Current, DC: Direct Current).

Therein, the inverter circuit includes at least two phases, which can also be referred to as strands or branches. Each phase is connected to a first contact of the direct signal connection with a first side and to a second contact of the direct signal connection with a second side. For example, a plus potential of the energy storage can be provided at the first contact. This side of the circuit is therefore also referred to as high side. For example, a minus potential of the energy storage can be provided at the second contact. This side of the circuit is therefore also referred to as low side. Thereto, the first contact can for example be connected to a positive pole of the energy storage and the second contact for example to a negative pole of the energy storage. The respective phases are in particular connected to the first and second contacts in electrical parallel connection with each other.

Each of the phases includes at least two first switching elements connected in series. Those of the first switching elements, which are directly or immediately connected to the positive potential, thus the first contact of the direct signal connection, in the respective phase, are also referred to as high-side switches in the following. Those of the first switching elements, which are directly or immediately connected to the negative potential, thus the second contact of the direct signal connection, are also referred to as low-side switches in the following.

In addition, each of the phases is connected to a respective contact of the alternating signal connection via a center tap between the at least two switching elements. Each center tap of a phase thus forms a contact of the alternating signal connection. For example, if three phases are present, the alternating signal connection can for example comprise exactly three contacts.

If the inverter circuit is for example formed in the manner of the initially mentioned two-level inverter, each phase can include exactly two serially connected first switching elements, the center taps of which are led to the contacts of the alternating signal connection. The topology with exactly two switching elements and center tap is also referred to as half bridge in the electrical engineering. In case of three phases, one designates this switching arrangement for example as a B6 bridge.

For forming a hybrid circuit, at least one second switching element, thus one or more second switching elements, is associated with each of the phases. Presently, it is in particular meant by associated, that each of the phases can be short-circuited via one or more second switching elements. For example, exactly one second switching element can be associated with each phase or each first switching element. Therein, the first and second switching elements are each formed as semiconductor switches of a different semiconductor technology, thus for example according to the MOSFET and the IGBT technology.

Now, the inverter switching arrangement includes at least also a controlling circuit. It is formed to operate the inverter circuit in a short circuit operation in a predetermined case of fault, presently in particular the active short circuit, as it was previously described, for short-circuiting the alternating signal connection by the respective phase and thereto switch the first and second switching elements in a predetermined switching operation. Put another way, the controlling circuit can control the switching elements in the switching operation such that the inverter circuit is operated in the short circuit operation. Therein, both types of switching elements, thus the first and second switching elements, are in particular switched to generate the desired short circuit. For example, the switching can be alternatingly or at least partially or temporarily simultaneously effected.

Hereby, the advantage arises that the active short circuit can be used as a measure for achieving a safe state and the high efficiency of conventional converters can be maintained in a normal operation, thus a converter operation, at the same time. Thus, according to choice of the semiconductor technology, the design limits for the semiconductor switches can in particular be complied with in case of fault such that defects can be avoided.

Presently, an electronic switch or also semiconductor switch is meant by a switching element. It is a component, which can be switched between conducting and blocking in forward direction and is typically conducting in reverse direction. Therein, forward direction or reverse direction in particular means that direction, in which a current flows through the switching element. This means that the switching element can be switched between at least two switching states. In the conducting state, an electrical current can flow across or through the switching element in substantially unimpeded manner. An electrical resistance of the switching element is thus low and negligible for the emulation of the alternating signal. In the blocking state, the switching element in contrast provides a substantially infinitely high electrical resistance for the current. Thus, no or only a negligibly low current flow across or through the switching element is possible.

For switching between the switching states, the respective switching element can be operated in the above mentioned switching operation. In the switching operation, it is switched between the conducting and blocking state according to a preset switching pattern or switching profile. By suitable choice of the switching pattern, the current and/or the voltage can be adjusted at the respective center tap. In particular, a temporal course can be adapted and/or an amplitude and/or a frequency for the alternating signal can be adjusted as the respective signal adjustment.

Presently, a switching element can in particular contain one or more electrical components such as for example one or more semiconductor switches and/or a diode. For example, the conduction in reverse direction can be achieved by an antiparallel diode, which is connected in parallel with the electronic switch. Presently, a switching element can for example also be implemented of a parallel connection of multiple similar semiconductor switches.

The first and second switching elements differ in their semiconductor technology. Thereby, it is in particular meant that the semiconductor switches have different characteristics for their respective design. Therein, the respective first switch may have a better conduction or switching behavior at low load, thus for example in a normal operation. The respective second switching element may have a better conduction behavior in the overload case (case of fault). Thus, less losses in particular occur at the second switching element in case of fault, and the second switching element for example heats less severely than the first one. The losses, which occur in the short circuit operation, can thus be distributed to the two switching elements. Further concrete details with respect to the semiconductor technologies are described in more detail in the later course.

Besides the short circuit operation, the initially mentioned normal operation can be performed by the inverter switching arrangement. In the normal operation, the controlling circuit is formed to operate the inverter circuit in a converter operation. In the operation in the converter operation, the inverter circuit is formed to convert the direct signal into the alternating signal and/or vice versa. In an example, the controlling circuit is formed to operate or to control only the first switching elements in a predetermined switching operation for the conversion in the converter operation. Therein, the switching operation for converting in particular differs from the switching operation for short circuiting. Alternatively, the second switching elements can of course also be controlled or used in the converter operation.

In the examples, additional advantages may arise, which also belong to the present invention.

According to an example, the controlling circuit is formed to control the switching operation of the first and second switching elements depending on a temperature value of the respective switching element. This means that the first and second switching elements can be switched between the conducting and blocking state depending on the temperature of the respective switching element. Thereto, the controlling circuit can for example measure the temperature of the respective switching elements or for example estimate or ascertain it depending on a current value of the current, which currently flows across the respective switching element. In an example, the respective switching element is only switched to conducting if a maximum temperature for the temperature value is for example undershot. The maximum temperature may be a temperature, from which a defect of the respective switching element occurs or is at least to be expected in longer operation at the maximum temperature. For example, the maximum temperature can be at about 175° C. in known semiconductor technologies.

According to an example, the controlling circuit is formed to control the switching operation of the first and second switching elements depending on a current value of the respective phase. This means that the controlling circuit can control the switching between the conducting and blocking state of the switching elements depending on current. Thereto, the controlling circuit can for example measure the current through the respective phase or at the respective switching element and select and adjust the switching operation for the respective switching element depending thereon. In an example, the switching operation for the respective second switching element is selected such that the respective second switching element is only connected, thus only connected into the conducting switching state, if the phase current exceeds a preset current limit value. This is in particular reasonable if the IGBT technology is for example selected for the second switching element. This is in particular due to the electrical characteristics of an IGBT, because if the overall switch current is low, the IGBT usually does not take a significant current portion. However, if the overall switch current is high, the IGBT takes the main current portion. The reason is its slower rising characteristic curve.

In an example, the control of the switching elements depending on temperature or depending on current is effected such that the first and second switching elements have substantially equalized temperatures, thus an equalized chip temperature. Thereto, it can be provided that the switching operation is selected by the controlling circuit such that the temperature values of the switching elements are in a preset approximation range to each other or to their respectively admissible maximum temperature. If the admissible maximum temperature of the switching elements should differ, thus, an equalized approximation to it could be reasonable. In the approximation range, the temperature values may deviate from each other by at most 10° C. to maximally 30° C.

According to an example, the inverter switching arrangement includes at least two controlling circuits. A first one of the controlling circuits is formed to control only the first ones of the switching elements. A second one of the controlling circuits is formed to control only the second ones of the switching elements. Here, the control in particular means the operation in the respective switching operation. This means that the semiconductor switches with different semiconductor technologies can be controlled with different or separate controlling circuits. Alternatively, an own controlling circuit can for example be provided for each of the switching elements.

Presently, a circuit is meant by a controlling circuit, which includes a superordinated or central control (control circuit) and one or more driver circuits. A driver circuit is a known type of electronic circuit, which is employed for controlling semiconductor switches. The driver circuit is formed to convert or translate a logic signal of a (central) control of the control circuit into a control signal suitable for the semiconductors. Therein, each driver circuit can in particular only respectively convert one logic channel. For example, the driver circuit can be formed as a driver IC (IC: integrated circuit). In an example, the driver circuit can provide an insulated voltage supply.

In contrast, the control circuit is formed to perform computing operations (for example the temperature comparison and/or the current comparison) and to generate the logic signal or logic pulses for operating the semiconductor switches. Presently, the control circuit can thus be understood as a data processing device or a processor device. Herein, the control circuit can comprise at least one microprocessor and/or at least one microcontroller and/or at least one FPGA (Field Programmable Gate Array) and/or at least one DSP (Digital Signal Processor). In particular, a CPU (Central Processing Unit) can respectively be used as the microprocessor. In an example, the control circuit is formed capable of real time. Furthermore, the control circuit can comprise program code, which is configured to perform the desired operation (converter operation, short circuit operation) of the inverter circuit upon execution by the control circuit. The program code can be stored in a data memory of the control circuit. The control circuit can be based e.g. on at least one circuit board and/or on at least one SoC (System on Chip).

Particularly, the respective controlling circuit can include exactly one driver circuit for multiple of the switching elements. For example, a first driver circuit can be provided for all of the first switching elements and/or a second driver circuit for all of the second switching elements. Alternatively, it is conceivable to provide an own or separate driver circuit for each of the switching elements. A variant is also conceivable, which mixes the two above mentioned alternatives. Thus, a separate driver circuit can for example respectively be provided for all of the first switching elements, while all of the second switching elements are controlled by a common driver circuit. If a driver circuit is used for multiple switches, they are in particular switched to conducting or blocking at the same time. The use of a common driver circuit is particularly inexpensive, but offers less optimization potential for the pulse patterns.

In an example, the respective controlling circuit includes exactly one control circuit. Advantageously, exactly one controlling circuit is implemented with exactly one control circuit and multiple driver circuits, as exemplarily described above.

According to an example, the respective second switching element has a higher thermal capacity than the respective first switching element at (substantially) identical current utilization. This means that the semiconductor technology is chosen such that the second switching element can absorb more energy or heat than the respective first switching element at identical or approximately identical current utilization. For example, this can be realized in that the second switching element has a larger thermal mass, thus for example a larger construction area or chip area, than the respective first switching element.

In an example, the respective first switching element has a higher switching speed than the respective second switching element. Hereby, the advantage arises that less conduction losses arise for example in operating in the normal operation and the normal operation can be further performed as heretofore substantially without restrictions.

According to an example, the respective first switching element is formed as a semiconductor switch from the group of the unipolar semiconductor switches. The respective second switching element is formed as a semiconductor switch from the group of the bipolar semiconductor switches. The semiconductor switch technologies differ in their behavior and/or in their electrical characteristics. This difference in particular results from the different layer structure of the switching elements.

In contrast to unipolar semiconductor switches, bipolar semiconductor switches use both majority charge carriers and minority charge carriers for the current conduction. In unipolar semiconductor switches, in contrast, only the majority charge carriers are involved in the current conduction. Whether the minority charge carriers and the majority charge carriers are electrons or holes, depends on the respective type or construction (P-channel, N-channel) of the respective semiconductor switch.

According to an example, the respective first switching element is formed as a semiconductor switch from the group of the MOSFETs or HEMTs (High Electron Mobility Transistor). A HEMT is a known semiconductor technology, which belongs to the group of the field effect transistors. It is also referred to as MESFET (Metal Semiconductor Field Effect Transistor). Both MOSFETs and HEMTs belong to the group of the unipolar semiconductor switches. This type of the semiconductor switches shows its efficiency in the low-load case, thus in the converter operation, since they can herein in particular be operated with particularly low switching losses.

The respective second switching element is formed as a semiconductor switch from the group of the IGBTs or GTOs (Gate Turn-off) or the thyristors. A so-called triac can for example be used as the thyristor. IGBTs, GTOs and thyristors belong to the group of the bipolar semiconductor switches. This type of the semiconductor switches in particular has larger dimensions, which results in a larger thermal mass and thereby in a slower temperature rise in the short circuit operation.

According to an example, for forming the hybrid circuit, a second switching element is connected in parallel either with all of the first switching elements or each of the first switching elements, which are immediately connected to the first or the second contact in the respective phase. Thus, the hybrid circuit or a hybrid switch includes a parallel connection of a first and a second switching element. Therein, either all of the first switching elements, thus both the high-side and the low-side switches, or only the low-side or only the high-side switches can be equipped or fitted with a second switching element connected in parallel. Hereby, a particularly simple and efficient implementation of the hybrid circuit arises.

According to an example, for forming the hybrid circuit, exactly one second switching element is connected to each phase. Therein, the second switching elements are connected to each other in a star connection. This means that the second switching elements are directly connected to each other, each with a first end. With the respective other end, the switching elements are connected to one of the phases, in particular at the center tap thereof.

According to an example, alternatively thereto, the respective phases are connected to each other via a delta connection of second switching elements for forming the hybrid circuit. Therein, the second switching elements are formed as bidirectionally blocking semiconductor switches, such as for example as a triac. For realizing the delta connection, two phases can for example respectively be connected to each other via a common second switching element. Hereby, an electrical circuit in the manner of a delta arrangement arises.

A further aspect of the examples of the invention relates to a motor vehicle with an inverter switching arrangement, as it was previously described. In an example, the motor vehicle is an electrically operated motor vehicle and can thus be understood as a system with electric drive. Thereto, the motor vehicle includes an electrical machine, thus an electric motor, which is connected to the alternating signal connection. Furthermore, the motor vehicle includes an electrical energy storage, thus for example a drive battery, which is connected to the direct signal connection. Thus, the electrical machine can be understood as a component, which is formed for operating with the alternating signal. The energy storage can be understood as a component, which is formed for operating with a direct signal.

In an example, the motor vehicle may be a car, in particular as a passenger car or passenger bus or motorcycle or truck.

According to a further aspect, the examples of the present invention may relate to a method for operating an inverter switching arrangement, as it was exemplarily described above. Therein, the operation of a system with electric drive is to be realized by the operation of the inverter switching arrangement. Therein, by the controlling circuit of the inverter switching arrangement, the above mentioned inverter circuit is operated for short circuiting the alternating signal connection by the respective phase in a predetermined case of fault, in a short circuit operation. This means that the controlling circuit controls the inverter circuit in the short circuit operation. Therein, the first and second switching elements are switched in a predetermined switching operation. In the switching operation, the switching is in particular effected such that the first or second switching elements are for example repeatedly switched into the conducting switching state for example in alternating or simultaneous manner and thereby the alternating signal connection is short circuited. Thereby, it is avoided that the electrical machine for example supplies a DC voltage intermediate circuit, thus for example the battery or other components, which are for example connected to an on-board power supply of the motor vehicle, with energy. Instead, the electrical energy, which the electrical machine generates as a generator, is discharged via the phases and the electrical machine can quasi settle.

For application cases or application situations, which can arise in the method and which are not explicitly described here, it can be provided that an error message is output and/or a default setting and/or a predetermined initial state are adjusted according to the method.

Developments of the method according to the examples and of the motor vehicle according to the examples, which comprise features, as they have already been described in context of the developments of the inverter switching arrangement according to the examples, also belong to the invention. For this reason, the corresponding developments of the method according to the examples and of the motor vehicle according to the examples are not again described here.

The invention also includes the combinations of the features of the described examples. Thus, the invention also includes realizations, which each comprise a combination of the features of multiple of the described examples if the examples have not been described as mutually exclusive.

### BRIEF DESCRIPTION OF THE DRAWINGS

In the following, examples of the invention are described. Hereto, there shows:

FIG. 1 is a schematic representation of a system with electric drive and an inverter switching arrangement according to a first example;

FIG. 2 is a schematic representation of an inverter switching arrangement according to a second example;

FIG. 3 is a schematic representation of an inverter switching arrangement according to a third example, and

FIG. 4 is a schematic method flow diagram with individual method steps for a method for operating a corresponding inverter switching arrangement.

### DESCRIPTION

The executions explained in the following are examples of the invention. In the execution examples, the described components of the examples each may represent individual features to be considered independently of each other, which also each develop the examples independently of each other. Therefore, the disclosure also is to include combinations of the features of the examples different from the illustrated ones. Furthermore, the described examples can also be supplemented by further ones of the already described features of the examples.

In the figures, identical reference characters each denote identical elements.

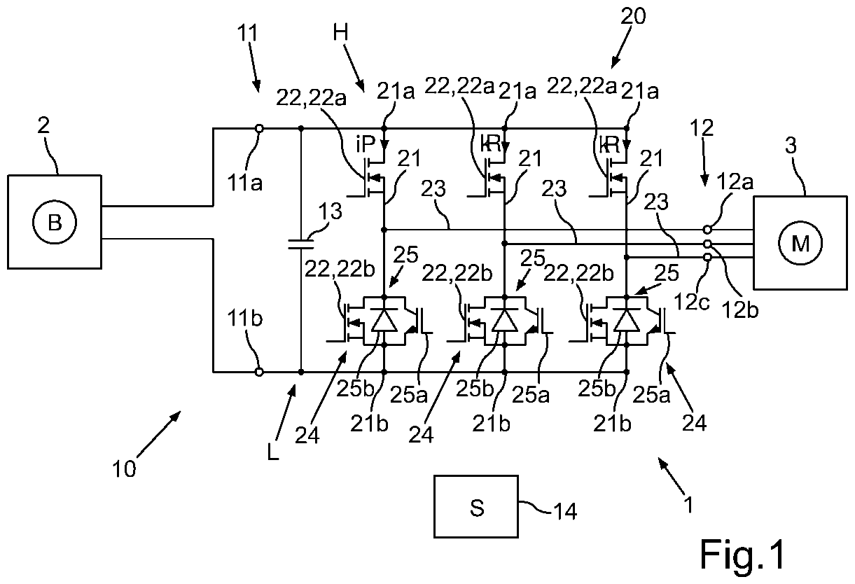

FIG. 1 shows a system 1 with electric drive 3 in schematic representation. The system can for example be a motor vehicle, in particular an electric vehicle, such as for example a passenger car with electric drive. The system 1 for example includes a high-voltage on-board power supply 2 with an electrical energy storage, which is for example formed as a drive battery or traction battery for the motor vehicle. The high-voltage on-board power supply 2 is a component, which is designed for an operation with a direct signal. This means that the high-voltage on-board power supply, in particular the battery, requires a direct current or a DC voltage for the operation thereof. For example, the battery provides such a direct signal for the energy supply of further components in the system 1.

One of the components can for example be an electrical machine 3 or an electric motor. For example, the electrical machine 3 can be used for the drive, thus for example for operating a powertrain of the motor vehicle. In contrast to the high-voltage on-board power supply, the electrical machine 3 is a component, which is designed for an operation with an alternating signal. This means that the electrical machine 3 requires an AC voltage and/or an alternating current for the operation thereof.

In order that the high-voltage on-board power supply 2 can supply the electrical machine 3, a conversion of the signal form, thus of the direct signal into the alternating signal, is required. Thereto, the system 1 includes an inverter switching arrangement 10, which is also referred to as drive converter or converter in the following. The converter includes a direct signal connection 11 and an alternating signal connection 12. The high-voltage on-board power supply 2 is connected to the inverter switching arrangement 10 via the direct signal connection 11. Thereto, the direct signal connection includes two contacts or connection poles, namely a first contact 11a and a second contact 11b.

Analogously, the electrical machine 3 is connected to the inverter switching arrangement 10 via the alternating signal connection 12. Presently, the electrical machine is exemplarily formed three-phase. Therefore, the alternating signal connection 12 presently also includes three contacts 12a, 12b, 12c, which each connect or link one phase of the electrical machine 3 to the inverter switching arrangement 10.

In parallel connection with the direct signal connection 11, the inverter switching arrangement includes an electrical capacitor 13 or an electrical capacitance. This capacitor 13 is typically employed for signal filtering or signal smoothing in a converter. Furthermore, the inverter switching arrangement 10 includes an inverter circuit 20. It is also referred to as AC/DC converter. The inverter circuit 20 couples or connects the direct signal connection 11 to the alternating signal connection 12. Thereto, the inverter circuit 20 is electrically connected in parallel with the capacitor 13 with the respective connection 11, 12.

The inverter switching arrangement 10 is formed to convert the direct signal, which is provided by the high-voltage on-board power supply 2, into the alternating signal for operating the electrical machine 3 and vice versa in a normal operation.

In an example, the inverter circuit 20 is formed in the manner of a two-level inverter. This means that the inverter circuit 20 presently includes three phases 21 analogously to the electrical machine 3. The respective phase 21 is (immediately) connected to the first contact 11a of the direct signal connection 11 with the first side 21a. With a second side 21b, the respective phase 21 is (immediately) connected to the second contact 11b of the direct signal connection 11. This means that the three phases 21 are connected to the direct signal connection 11 in electrical parallel connection with each other.

Each phase 21 is formed as a so-called half bridge. This means that each of the phases 21 includes two first switching elements 22 connected in series. In addition, each of the phases 21 includes a center tap 23 between the two serial first switching elements 22. Presently, three such center taps 23 are thus present, which are each connected to a contact 12a, 12b, 12c of the alternating signal connection 12. By the center tap 23, each half bridge is divided into a high side H and a low side L. Those of the first switching elements 22, which are connected between the respective center tap 23 and the first side 21a, are therefore also referred to as high-side switches 22a. Those of the first switching elements 22, which are connected between the respective center tap 23 and the second side 21b, are also referred to as low-side switches 22b.

In the present example, the first switching elements 22 are formed as so-called MOSFETs (metal oxide semiconductor field effect transistor). In the example in FIG. 1, a self-blocking enhancement type of an N-channel MOSFET is in particular represented. In an example, it can be a silicon carbide (SiC) MOSFET. Alternatively, other semiconductor technologies from the group of the unipolar semiconductor switches are of course also employable as the first switching elements. For example, a silicon MOSFET or a HEMT, for example based on gallium nitrate (GaN), can be used. Semiconductor switches from the group of the unipolar semiconductor switches have the advantage that they have a very good (fast) switching behavior and little conduction or switching losses in particular in the low-load case. Thus, a normal operation or converter operation of the inverter circuit 20 can in particular be particularly efficiently performed.

For performing the converter operation or normal operation, the inverter switching arrangement 10 includes a controlling circuit 14. The controlling circuit 14 can comprise a superordinated control (control circuit) and one or more driver circuits. The control circuit can for example include one or more microcontrollers or microprocessors, by which a logic signal for controlling the switching elements 22, 25 can be provided. The respective driver circuit is employed as a driver and can bring the logic signal into a suitable signal form for the respective switching element 22, 25. For example, a current strength and/or a voltage of the logic signal can be adapted. Control circuit and driver circuit(s) are thus collectively used to implement the converter operation or normal operation.

For converting the direct signal into the alternating signal and vice versa, the controlling circuit 14 can operate the first switching elements 22 in a predetermined switching operation. In the switching operation, the switching elements 22 are set from a conducting into a blocking state and vice versa. The switching is effected according to a predetermined switching pattern such that the desired output signal, thus the alternating signal, with the desired characteristics appears. Such a converter operation is known per se from inverters.

However, the present inverter switching arrangement 10 is to be designed not only for the normal operation, but also for a short circuit operation. In the short circuit operation, the point is in bringing the system 1 into a safe state if a case of fault is for example present in the electrical machine 3 or the on-board power supply. Since the electrical machine 3 optionally further rotates in the case of fault and thus can act as a generator, it is important not to allow the electrical energy generated hereby to enter the high-voltage on-board power supply 2. Thereto, the converter switches into a safe state in the case of fault. Hereto, the so-called active short circuit may be employed. Therein, all of the high-side switches 22a or all of the low-side switches 22b are controlled in conventional inverters such that the motor input, thus the contacts 12a to 12c, is short-circuited via the respective switching elements 22. For example, the short circuit operation can be effected by controlling the high-side or low-side switches 22a, 22b by the controlling circuit 14. Therein, either the high-side or the low-side switches 22a, 22b are connected through, thus set into the conducting state.

In the short circuit operation, the electrical machine 3 generates current pulses with very high amplitude for a short time. They result in losses in the semiconductor switches of the converter, which extend beyond the usual design limits thereof in the normal operation. Namely, heat arises by the losses, whereby the respective switching element 22 heats, wherein a maximum temperature of for example 175 degrees must not be exceeded. From this maximum temperature, a defect of the switching element 22 can occur. Thus, it has to be ensured with an active short circuit as the safe state that the maximum temperature of the semiconductor switches does not exceed the maximum value. However, the forward voltage of MOSFETs more severely increases at high currents, whereby they can heat very severely beyond the maximum temperature.

Therefore, the inverter circuit 20 is presently equipped with a hybrid circuit 24. For the hybrid circuit, at least one second switching element 25 is associated with each of the phases 21. The second switching elements 25 have a different semiconductor technology compared to the first switching elements 22. In particular, semiconductor switches from the group of the bipolar semiconductor switches are selected for the second switching elements 25. In the present example, the respective second switching element 25 comprises a semiconductor switch 25a from the group of the bipolar semiconductor switches. Presently, the semiconductor switch 25a is for example an IGBT (insulated gate bipolar transistor), for example, a Si IGBT. For forming the second switching element 25, a diode 25b is additionally connected in parallel with the semiconductor switch 25a. It is also referred to as antiparallel diode 25b.

Compared to the MOSFET, IGBTs have an inferior switching or conduction behavior in the low-load case. However, in return, the conduction losses are reduced in an IGBT compared to the MOSFET in the overload case. Basically, it applies: in MOSFETs, the forward voltage first rises proportionally with the current and in over-proportional manner at higher currents up to the desaturation of the component, at which the current is limited. In contrast, the transfer characteristic curve of the IGBT first logarithmically rises until reaching the threshold voltage, subsequently the forward voltage considerably slower rises in a similarly dimensioned component than in MOSFETs until the IGBT also reaches a desaturation state. In case of a short-term current overload, as it occurs in an active short circuit (AKS), this results in a considerably lower energy input into the component, thus the IGBT. In addition, an IGBT designed to the same current is larger in its dimensions, which results in a larger thermal mass and thereby in a slower temperature rise in case of fault.

A converter equipped with hybrid switches now combines the advantages of both technologies. On the one hand, it shows an efficiency in the low-load case, which is above that of a converter based on IGBT and approaches that of a converter based on MOSFET. On the other hand, the temperature rise in case of an AKS is lower with respect to a converter based on MOSFET and approaches the values of the IGBT. Thus, the idea is in equipping the converter with hybrid switches, which are designed such that the maximally admissible chip temperatures are complied with in the AKS and the over-currents thereof to be expected.

Thereto, the first and second switching elements 22, 25 can be operated in a predetermined switching operation in the short circuit operation by the controlling circuit 14. In the switching operation, the first and second switching elements 22, 25 can for example be alternatingly and simultaneously (repeatedly or permanently) switched into the conducting state such that the short circuit is generated for the electrical machine 3.

Other than illustrated in FIG. 1, the inverter switching arrangement 10 can for example include more than one controlling circuit 14, such as for example two controlling circuits 14. Therein, each of the controlling circuits 14 can be formed for operating either the first switching elements 22 or the second switching elements 25. Thus, a separate control of the switching elements 22, 25 can be effected. In an example, each controlling circuit 14 can include exactly one control circuit. In particular, the controlling circuit 14 for the first switching elements 22 can include a driver circuit for each of the first switching elements 22. In contrast thereto, the controlling circuit 14 for the second switching elements 25 can include a common driver circuit for all of the second switching elements 25. Thus, the control can be particularly inexpensively implemented.

Different circuit topologies are possible for the hybrid circuit 24. In FIG. 1, an example is shown, in which the hybrid circuit 24 is formed as a parallel connection of each a first switching element 22 and a second switching element 25. Therein, only the low-side switches 22b are in particular equipped with the second switching element 25 for forming the hybrid switch 24. Overall, the inverter circuit 20 thus includes exactly three hybrid circuits 24. Alternatively, it would for example be conceivable to form only the high-side switches 22a as hybrid switches or to implement the high-side and low-side switches 22a, 22b as hybrid switches.

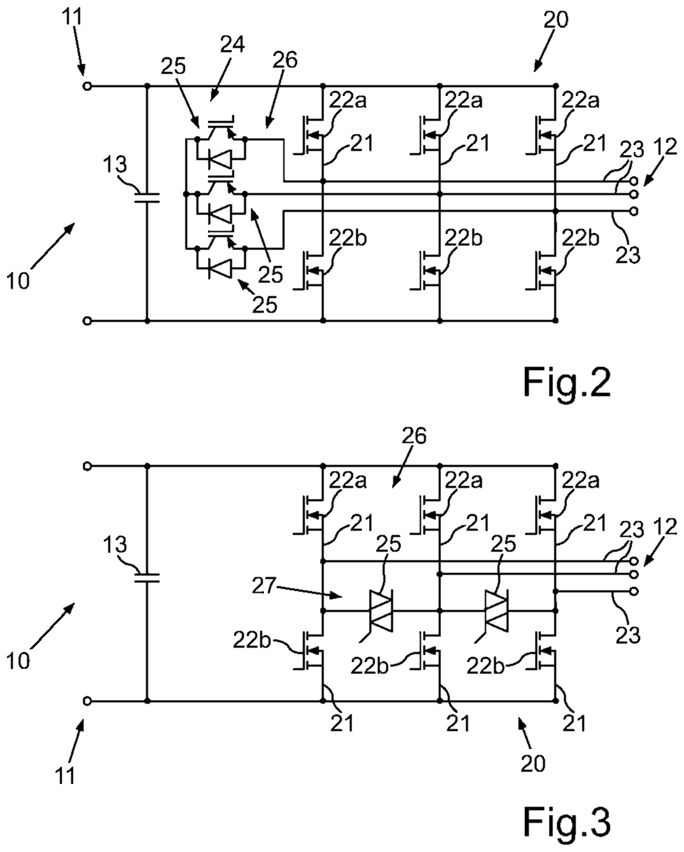

FIG. 2 and FIG. 3 show examples of the inverter switching arrangement 10, in which another topology is selected for forming the hybrid circuit 24. According to the example in FIG. 2, exactly one second switching element 25 is connected to each phase 21, wherein the second switching elements 25 are connected to each other in a so-called star connection 26. For forming the star connection 26, the switching elements 25 are commonly connected with one side and connected to each one of the phases 21, in particular the center tap 23 thereof, with the respectively other side. The second switching elements 25 according to FIG. 2 are formed analogously to the second switching elements 25 according to FIG. 1.

According to the example in FIG. 3, a delta connection 27 or delta arrangement is selected as the topology for the hybrid circuit 24. Thereto, the phases 21 are connected to each other via the delta connection 27 of second switching elements 25. In this example, the second switching elements 25 are formed as bidirectionally blocking semiconductor switches, in particular as triacs.

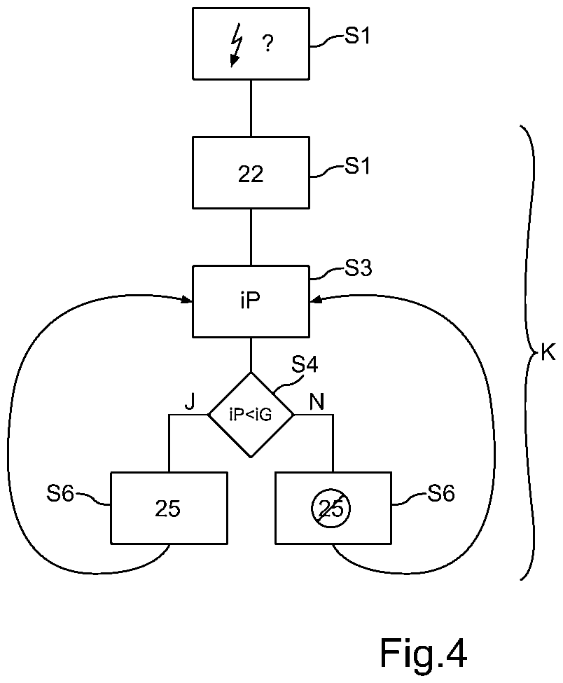

Based on FIG. 4, the short circuit operation of the inverter circuit 20 for operating the inverter switching arrangement 10 in the active short circuit is now to be described in more detail. Thereto, FIG. 4 shows a schematic method flow diagram with individual method steps for operating the inverter switching arrangement 10 as it has for example been described in the preceding examples. The method described in the following can for example be performed or executed by the controlling circuit.

In a step S1 of the method, the case of fault is first detected. The case of fault can for example be a defect in the high-voltage on-board power supply 2 or in the electrical machine 3. For detecting the case of fault, the controlling circuit 14 can for example obtain a corresponding warning signal from suitable measurement electronics of the system 1. If the case of fault is detected, the short circuit operation for the inverter circuit 20 is implemented or initiated by the controlling circuit 14. In the following, the short circuit operation K is exemplarily summarized in four method steps. These method steps can be examples of how the short circuit K can be implemented.

The short circuit operation begins in a step S2. In a step S2, the first switching elements 22 are controlled such that the motor inputs are short-circuited. Thereto, the low-side switches 22b (MOSFETs) are presently for example set into the conducting state. In contrast, the high-side switches 22a are set into the blocking state. The second switching elements 25 are also switched to blocking in the step S2. Thereafter, the method is continued in a step S3.

In the step S3, a phase current iP of the respective phase 21 is for example ascertained. This means that the phase current iP can for example be measured by suitable measurement electronics, such as for example a current measuring sensor. Therein, the phase current iP is that current by short-circuiting the phases 21, which flows through the respective phase 21 and thus across the low-side switches 22b by the operation of the electrical machine 3.

Subsequently, it is examined in a step S4 if the phase current iP falls below a preset limit value iG. The limit value is a preset limit value for the phase current, which serves as a measure for heating of the respective switching element 22, 25. For example, the limit value can be ascertained or determined by test experiments or simulations. Thus, by the phase current, it can be inferred how severely the respective switching element 22, 25 heats, thus which temperature value the respective switching element 22, 25 currently has. If it is determined in step S4 that the phase current iP is less than the limit value iG, the method is continued in a step S5.

In the step S5, the second switching elements (IGBTs) are also switched to conducting. This means that the phase current iP can flow off both across the MOSFETs and the IGBTs of the hybrid circuit 24. Hereby, the component heating can be uniformly distributed to the MOSFETs and IGBTs.

In contrast, if it is determined in step S4 that the phase current iP is greater than the limit value iG or corresponds to it, the method is continued in a step S6. In the step S6, the blocking state of the second switching elements 25 is maintained. This means that the phase current iP also further flows off only across the MOSFETs and not the IGBTs.

Starting from the steps S5 and S6, the method is repeated beginning with step S3 until the short circuit operation K is terminated. The short circuit operation K is or can for example be terminated if the electrical machine 3 has settled, thus, current pulses are no longer fed into the converter from the electrical machine 3.

In FIG. 4, thus, a short circuit operation K is shown, in which the control of the hybrid circuit 24 is effected depending on current. Alternatively, it is for example possible to perform the short circuit operation depending on temperature. Thereto, the temperature of the switching elements 22, 25 can for example be monitored by a temperature sensor and the switching operation can be selected depending thereon.

In the short circuit operation K according to FIG. 4, it thus can occur that the first and second switching elements 22, 25 of the hybrid circuit 24 are at least temporarily switched to conducting at the same time or in simultaneous manner. Of course, other operating modes are also possible. For example, if a component more severely heats than the other one, it can be reasonable that, below a limit value for the current or the temperature, at which the less severely heating component (switching element) can carry the current occurring in the active short circuit alone, only this one is switched on, and the more severely heating component temporarily remains switched off to equalize the temperature of the two components. Hereto, it is advantageous to implement a separable control of the two switching elements 22, 25, thus multiple controlling circuits 14.

The design to a respective rated current as the phase current, which flows across the respective switching element 22, 25, can for example be ascertained based on test experiments and thus a suitable hybrid circuit 24 can be selected. For example, it can be examined in experiments, which temperatures arise for the respective hybrid circuit if the IGBT carries 75% and the MOSFET 25% of the current at the respective phase current or a division of 50:50 or 25:75 is selected on the assumption that a maximum chip temperature of 175° C. is for example admissible. Among these divisions, that combination is to be selected, which seems to be most advantageous for the other design for example for the efficient normal operation or lower production costs.

Overall, the examples show the employment of a hybrid switch structure for optimizing a converter with the ability of switching active short circuits in terms of the functional safety. Thus, the point is the optimization of a converter in case of an active short circuit by hybrid switches.

A description has been provided with particular reference to examples, but it will be understood that variations and modifications can be affected within the spirit and scope of the claims, which may include the phrase “at least one of A, B and C” as an alternative expression that refers to one or more of A, B or C, contrary to the holding in Superguide v. DIRECTV, 358 F3d 870, 69 USPQ2d 1865 (Fed. Cir. 2004).

1. An inverter switching arrangement to operate a system with an electric drive, comprising:
an alternating signal connection to connect a component, and which is configured to operate with an alternating signal,
a direct signal connection to connect a component, and which is configured to operate with a direct signal,
an inverter circuit, which couples the alternating signal connection and the direct signal connection to each other,
wherein the inverter circuit includes at least two phases, which are connected to a first contact of the direct signal connection with a first side and to a second contact of the direct signal connection with a second side, respectively,
wherein each phase of the at least two phases includes at least two first switching elements connected in series, and each phase of the at least two phases is connected to a respective contact of contacts of the alternating signal connection, via a center tap,
at least one second switching element associated with each phase of the at least two phases to form a hybrid circuit,
wherein the at least two first switching elements are semiconductor switches of a semiconductor technology different from a semiconductor switch of a semiconductor technology of the at least one second switching element, and
at least one control circuit to operate the inverter circuit in a short circuit operation to short-circuit the alternating signal connection by each respective phase of the at least two phases in case of a fault, and to switch the at least two first switching elements and the at least one second switching element in a switching operation.

2. The inverter switching arrangement according to claim 1, wherein the at least one control circuit controls the switching operation of the at least two first switching elements and the at least one second switching element depending on a temperature value of a respective switching element of the at least two first switching elements and the at least one second switching element.

3. The inverter switching arrangement according to claim 1, wherein the at least one control circuit controls the switching operation of the at least two first switching elements and the at least one second switching element depending on a respective current value of each respective phase of the at least two phases.

4. The inverter switching arrangement according to claim 1, wherein the at least one control circuit comprises two control circuits,
wherein a first one of the two control circuits is to control the at least two first switching elements and a second one of the two control circuits is to control the at least one second switching element.

5. The inverter switching arrangement according to claim 1, wherein each second switching element of the at least one second switching element has a higher thermal capacity than each first switching element of the at least two first switching elements at identical current utilization.

6. The inverter switching arrangement according to claim 1, wherein each first switching element of the at least two first switching elements is a semiconductor switch from a group of unipolar semiconductor switches, and each second switching element of the at least one second switching element is a semiconductor switch from a group of bipolar semiconductor switches.

7. The inverter switching arrangement according to claim 1, wherein each first switching element of the at least two first switching elements is a semiconductor switch from a group of Metal Oxide Semiconductor Field Effect Transistors (MOSFETs) or High Electron Mobility Transistors (HEMTs), and each second switching element of the at least one second switching element is a semiconductor switch from a group of Insulated Gate Bipolar Transistors (IGBTs) or Gate Turn-off (GTOs) or thyristors.

8. The inverter switching arrangement according to claim 1, wherein to form the hybrid circuit, a second switching element of the at least one second switching element is connected in parallel with either all of the at least two first switching elements or with each first switching element of the at least two first switching elements which is immediately connected to the first contact of the direct signal connection or the second contact of the direct signal connection in each respective phase of the at least two phases.

9. The inverter switching arrangement according to claim 1, wherein to form the hybrid circuit, each second switching element of a plurality of second switching elements of the at least one second switching element is connected to each phase of the at least two phases, respectively,
wherein the plurality of second switching elements are connected to each other in a star connection.

10. The inverter switching arrangement according to claim 9, wherein to form the hybrid circuit, each phase of the at least two phases are connected to each other via a delta connection of the plurality of second switching elements, wherein the plurality of second switching elements are bidirectionally blocking semiconductor switches.

11. A motor vehicle with an inverter switching arrangement according to claim 1, including an electrical machine, which is connected to the alternating signal connection, and an electrical energy storage, which is connected to the direct signal connection.

12. The motor vehicle according to claim 11, wherein the at least one control circuit controls the switching operation of the at least two first switching elements and the at least one second switching element depending on a temperature value of a respective switching element of the at least two first switching elements and the at least one second switching element.

13. The motor vehicle according to claim 11, wherein the at least one control circuit controls the switching operation of the at least two first switching elements and the at least one second switching element depending on a respective current value of each respective phase of the at least two phases.

14. The motor vehicle according to claim 11, wherein each second switching element of the at least one second switching element has a higher thermal capacity than each first switching element of the at least two first switching elements at identical current utilization.

15. The motor vehicle according to claim 11, wherein each first switching element of the at least two first switching elements is a semiconductor switch from a group of unipolar semiconductor switches, and each second switching element of the at least one second switching element is a semiconductor switch from a group of bipolar semiconductor switches.

16. The motor vehicle according to claim 11, wherein each first switching element of the at least two first switching elements is a semiconductor switch from a group of Metal Oxide Semiconductor Field Effect Transistors (MOSFETs) or High Electron Mobility Transistors (HEMTs), and each second switching element of the at least one second switching element is a semiconductor switch from a group of Insulated Gate Bipolar Transistors (IGBTs) or Gate Turn-off (GTOs) or thyristors.

17. The motor vehicle according to claim 11, wherein to form the hybrid circuit, a second switching element of the at least one second switching element is connected in parallel with either all of the at least two first switching elements or with each first switching element of the at least two first switching elements which is immediately connected to the first contact of the direct signal connection or the second contact of the direct signal connection in each respective phase of the at least two phases.

18. The motor vehicle according to claim 11, wherein to form the hybrid circuit, each second switching element of a plurality of second switching elements of the at least one second switching element is connected to each phase of the at least two phases, respectively,
wherein the plurality of second switching elements are connected to each other in a star connection.

19. The motor vehicle according to claim 18, wherein to form the hybrid circuit, each phase of the at least two phases are connected to each other via a delta connection of the plurality of second switching elements, wherein the plurality of second switching elements are bidirectionally blocking semiconductor switches.

20. A method, comprising:
operating an inverter switching arrangement according to claim 1 to operate a system with an electric drive,
wherein to operate the inverter switching arrangement,
the at least one control circuit operates the inverter circuit in a short circuit operation to short circuit the alternating signal connection by each respective phase of the at least two phases in case of a fault, with the at least two first switching elements and the at least one second switching element switching in a switching operation.
